(19) United States
(12) Patent Application Publication
(10) Pub. No.: US 2009/0070141 A1
(43) Pub. Date: Mar. 12, 2009

(54) Method and System for Defining, Configuring, Deploying, Delivering, and Monitoring Health Improvement Programs

(75) Inventors: Jennifer Jolley, Mendham, NJ (US); Graham Cockell, Devon (GB)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Protocol Drive Healthcare, Inc.

(21) Appl. No.: 12/208,918

(22) Filed: Sep. 11, 2008

Related U.S. Application Data
(60) Provisional application No. 60/971,426, filed on Sep. 11, 2007.

(51) Int. Cl. G06Q 10/00

(52) U.S. Cl. 705/2

(57) ABSTRACT

A method and system for defining, configuring, deploying, delivering, and monitoring health improvement programs are described. According to one embodiment, a method, comprises defining health improvement program components. The health improvement program components are assembled into a plurality of configured health improvement program templates. One or more program templates of the plurality of configured health improvement program templates are configured to meet the requirements of a given population. The one or more health improvement program templates are deployed to a plurality of program participants within the population. a personalized health improvement program is delivered for each participant of the plurality of program participants within the population. Participant progress is monitored.

The present application claims the benefit of and priority to U.S. Provisional Patent Application No. 60/971,426 entitled “Method and System for Defining, Configuring, Deploying, Delivering, and Monitoring Health improvement Programs” and filed on Sep. 11, 2007, and is hereby, incorporated by reference.

### FIELD

The present invention relates to the field of computer systems. In particular the present invention discloses a system and method for defining, configuring, deploying, delivering and monitoring health improvement programs.

### BACKGROUND

In 2006, expenditures in the United States on health care exceeded $2 trillion, almost three times the $714 billion spent in 1990, and over eight times the $253 billion spent in 1981. In response to these rapidly increasing costs, payers, primarily government and employers, are looking to implement health improvement programs within their populations that are designed to reduce health risks, delaying or preventing the onset of chronic conditions such as diabetes and heart disease. To encourage compliance with the program, payers increasingly require that health improvement programs include incentives or awards that are earned by participants as they complete each activity within the program.

Most payers do not have sufficient internal resources to implement comprehensive health improvement programs within their own populations, where a population may represent, for example, employees for a given employer, students at a college, or members of a health plan, and rely on external wellness organizations. Wellness providers, which may be independent organizations, or divisions of a health plan, hospital system, or other healthcare provider, specialize in delivering health improvement programs and typically offer a range of service levels, or programs, to their clients. To be successful, these programs need to be further configured to meet the local requirements of each population, integrating with on-site wellness activities and resources available within the population.

### SUMMARY

A method and system for defining, configuring, deploying, delivering, and monitoring health improvement programs are described. According to one embodiment, a method, comprises defining health improvement program components. The health improvement program components are assembled into a plurality of configured health improvement program templates. One or more program templates of the plurality of configured health improvement program templates are configured to meet the requirements of a given population. The one or more health improvement program templates are deployed to a plurality of program participants within the population. a personalized health improvement program is delivered for each participant of the plurality of program participants within the population. Participant progress is monitored.

In one embodiment, the system includes storing program definitions in a database, configuring a program to meet a population's specific requirements, generating the participant program from the stored definitions, delivering it to an Internet browser, and tracking participant data as they proceed through the program.

### BRIEF DESCRIPTION OF DRAWINGS

FIG. 1 is a process flow diagram for implementing a health improvement program, according to one embodiment.

FIG. 2 is a process flow diagram illustrating the process used to define components of a health improvement program, according to one embodiment.

FIG. 3 is a process flow diagram illustrating the process used to configure a health improvement program timeline, according to one embodiment.

FIG. 4 is a process flow diagram illustrating the process used to deploy a health improvement program to a population of participants, according to one embodiment.

FIG. 5 is a process flow diagram illustrating the process used to deliver a health improvement program to a participant, according to one embodiment.

FIG. 6 is a process flow diagram illustrating the process used to monitor participant progress through a health improvement program, according to one embodiment.

FIG. 7 is a diagram depicting the flow and storage of data involved in the implementation of a health improvement program, according to one embodiment.

FIG. 8 is a block and flow diagram depicting the process of implementing a health improvement program, according to one embodiment.

FIG. 9 illustrates a user interface for defining program components, according to one embodiment.

FIG. 10 illustrates a user interface for configuring program templates from program components, according to one embodiment.

FIG. 11 illustrates a user interface for assigning program templates configured to specific populations and for customizing assigned templates to meet requirements of a given population, according to one embodiment.

FIG. 12 illustrates a user interface for delivering customized programs to participants within a population, allowing a participant to complete activities, earn incentive points, and monitor his/her progress through the program, according to one embodiment.

### DETAILED DESCRIPTION

A method and system for defining, configuring, deploying, delivering, and monitoring health improvement programs are described. According to one embodiment, a system and methodology for defining, configuring, deploying, delivering, and monitoring customized, incentive-driven health improvement programs to many populations is disclosed. The system includes support for multiple health improvement programs or service levels, each requiring different activities and durations. According to one embodiment, the system allows these programs to be customized to meet the local requirements of populations of participants, incorporating information and business rules specific to each population. The system allows incentive points to be allocated to activities within each health improvement program and for the value of these points and the total incentive budget available to be customized for each population.

Wellness providers require an integrated system and methodology that allows them to deliver health improvement programs to many populations, where a population may represent, for example, employees for a given employer, students at a college, or members of a health plan.

Wellness providers may deliver a number of different health improvement programs, or service levels, each requiring different activities and durations. These programs may also require some customization for each population to accommodate the resources and wellness activities that are available within the population. Wellness providers need a system that defines the programs available, assigns one or more programs to participants in a population, delivers the program to participants, tracks progress, and allows monitoring both for individual participants and for the population in aggregate.

Health improvement programs may include incentives or awards that are earned by participants as they complete each phase of a program. Wellness providers require a system to assign incentive points to activities, configure the value of incentive points for each population, deliver this localized program to participants within the population, and track points as they are earned for individual participants and for the population in aggregate.

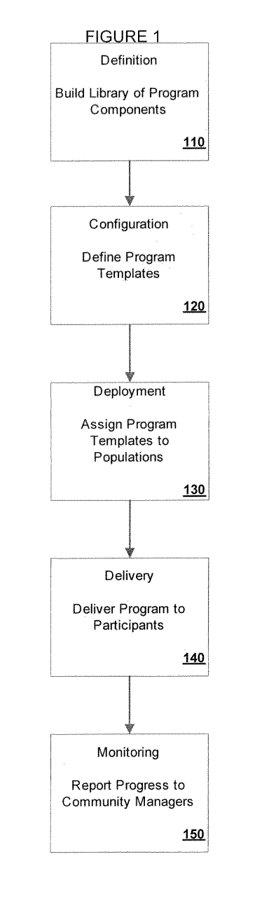

FIG. 1 is a process diagram for implementing a health improvement program, according to one embodiment. The process provides an efficient and flexible system for the implementation of a wide variety of health improvement programs.

Components of a health improvement program are defined 110, such as tutorials, assessments, trackers and reminders. The program components are then assembled into a schedule that configures 120 the overall program timeline. Incentive points may also be assigned to the program and business rules may be defined for enrollment and completion of programs. The configured program is then deployed 130 to a group of participants (i.e. a population (community)) and parameters that control program availability and access are defined. This may include, as an example, program enrollment dates, incentive budgets and other information specific to the population (community). Based on this defined metadata, a personalized health improvement program is instantiated for an individual user. This program is delivered 140 to the user's browser in a form that allows the user to enroll, complete activities, record progress, and review incentive points earned as they move through the program. User progress may be monitored 150 as they move through their individual programs, including steps and programs completed and incentive points earned.

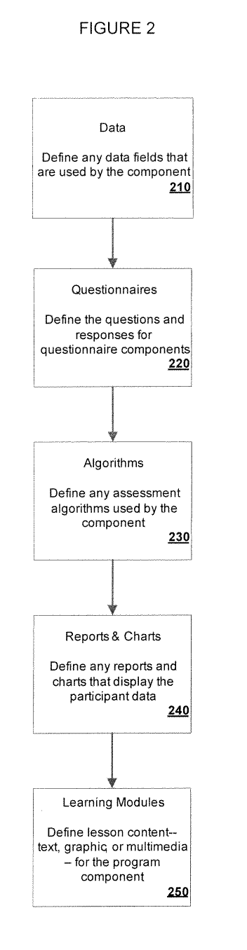

FIG. 2 is a process flow diagram illustrating the process used to define components of a health improvement program, according to one embodiment. This process allows a wellness provider or system administrator to create a set of program components, e.g. assessments, trackers, tutorials, which can be used by many programs, providing consistency across programs and reducing the time and effort required to set up each program.

Data items 210 are defined for each program component that requires data collection. The data item definitions are used to build database tables in which participant data is stored when the program is delivered. Questions, and permitted responses to each of the questions, are then defined to build questionnaires 220 for participants to provide program data, for each program component that incorporates questionnaires. Participant assessment and tracking questionnaires are also built using the questionnaire definitions. Assessment algorithms 230 are built for each program component that incorporates an assessment. The assessment algorithms are used to build assessment rules and other business rules that are applied to program data. Reports and charts 240 are defined that display participant data for each program component that incorporates a report or chart. The reports and charts are used to create health improvement plans and progress charts from participant data collected. Lesson content is defined 250 which may include text, graphics, or multimedia elements, for each program component that incorporates a learning module. The lesson content is used to create online learning modules to present to the participant.

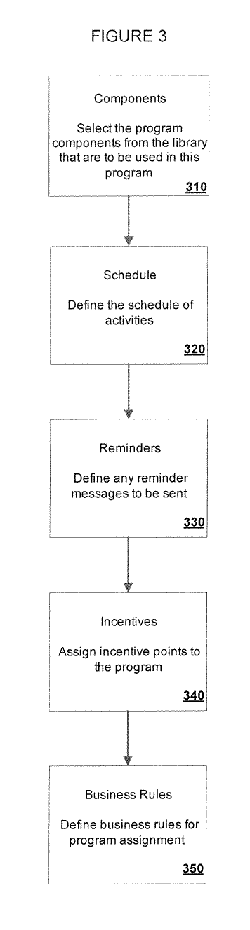

FIG. 3 is a process flow diagram illustrating the process used to configure a health improvement program timeline, according to one embodiment. This process allows for the creation of a series of program templates, each comprising different activities and durations, that map to the service levels offered by the organization. For example, a provider may offer a premium service which includes a 12 week program for weight management and 3 coaching sessions. As another example, a provider may offer a basic service which includes an 8 week self-directed program for healthy eating with no coach services.

According to one embodiment, selected program components 310 from the library are used in a specific program template. Each program component may be used one or more times within a program template and in an unlimited number of different program templates. A schedule 320 of activities is defined to make up the program template. This schedule may include the order or sequence in which components are to be completed, or the time intervals between components, as examples. Reminder 330 messages may be sent to participants for each activity within the program schedule. Reminder messages may be used to inform participants of activities that are up-coming or of activities that are overdue. Incentive points 340 may be earned by participants in the program. Incentive points may be assigned to each program activity and also to overall program completion. Finally, business rules 350 are used for the assignment of the program to participants. Programs may be assigned by a coach or administrator, assigned automatically by the system based on a participant's health risks, or self-enrolled by the participant at his/her discretion.

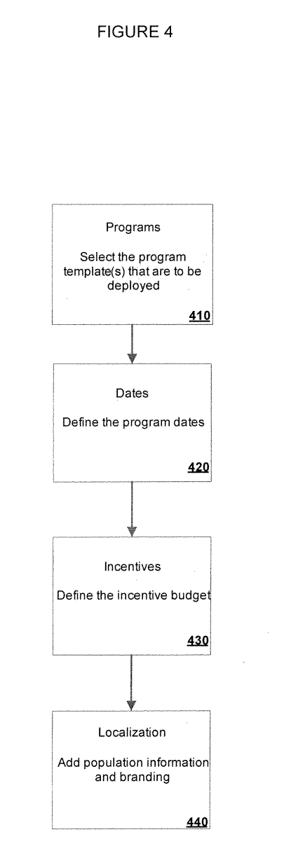

FIG. 4 is a process flow diagram illustrating the process used to deploy a health improvement program to participants, according to one embodiment. A program is created and deployed to participants in a given population. Each program template is customizable to meet the requirements of the given population, including the dates on which the program is made available, the value of the incentives offered, and the total incentive budget available. Information and branding specific to the given population may also be incorporated to provide a further degree of localization. Program templates 410 are selected to be deployed to the population. Each program template may be used by one or more populations and each population may deploy one or more program templates. Program dates 420 are defined for the population. These dates include the beginning and end of the program enrollment period and the start and stop date for the program. An incentive budget 430 is defined for the program in the population and also a total incentive budget for all programs in the population. Any population specific information and branding (e.g. graphics, logos, and names) may be added to the program for localization 440.

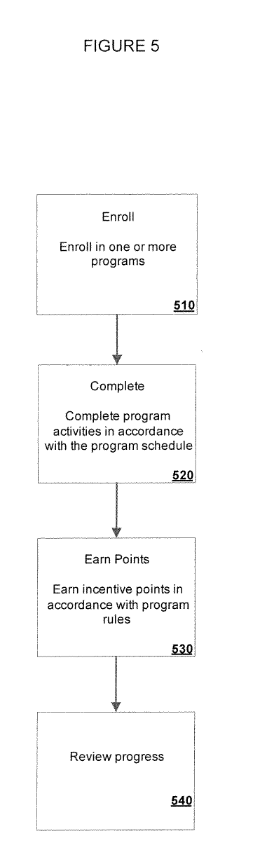

FIG. 5 is a process flow diagram illustrating the process used to deliver a health improvement program to a participant, according to one embodiment. Program participants within a population can enroll 510 in a customized program, complete activities, earn incentive points, and monitor his/her progress through a user interface.

Based on the program business rules and population deployment dates, a participant may be enrolled into one or more programs by a coach or administrator, auto-enrolled by the system into one or more programs based on health risks, or have the ability to self enroll into one or more programs at the participant's discretion.

The participant may complete activities 520 in accordance with the program schedule and population deployment dates. Reminders are delivered to the participant for upcoming activities and for activities that are overdue. The participant earns incentive points 530 for completing activities in accordance with defined incentive budget and budget limits. Finally, the participant may monitor and review 540 progress through each program, including activities completed, activities outstanding, points earned, and progress towards achieving individual health goals.

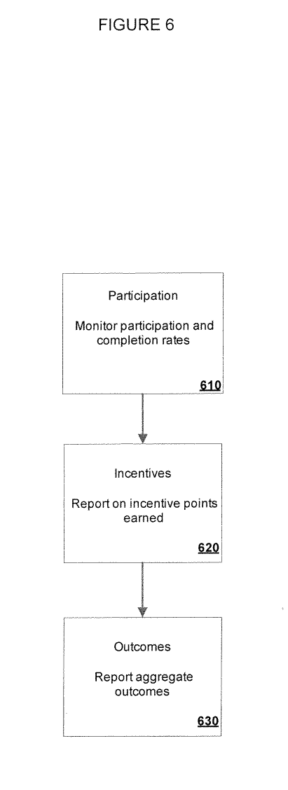

FIG. 6 is a process flow diagram illustrating the process used to monitor participant progress through a health improvement program, according to one embodiment. Participation rates, incentives earned, and program outcomes to population managers on a periodic basis may be reported.

Reports are generated detailing program participation 610 for the population as a whole, for a program within a population, or for specific activities within a program. Reports may be generated detailing the incentive points earned 620 for each program participant and for the population as a whole, enabling plan managers to fulfill incentives, e.g. through cash payments, or gift cards. Reports may also be generated showing progress within the population towards health goals or outcomes 630, e.g. weight loss, blood pressure reductions.

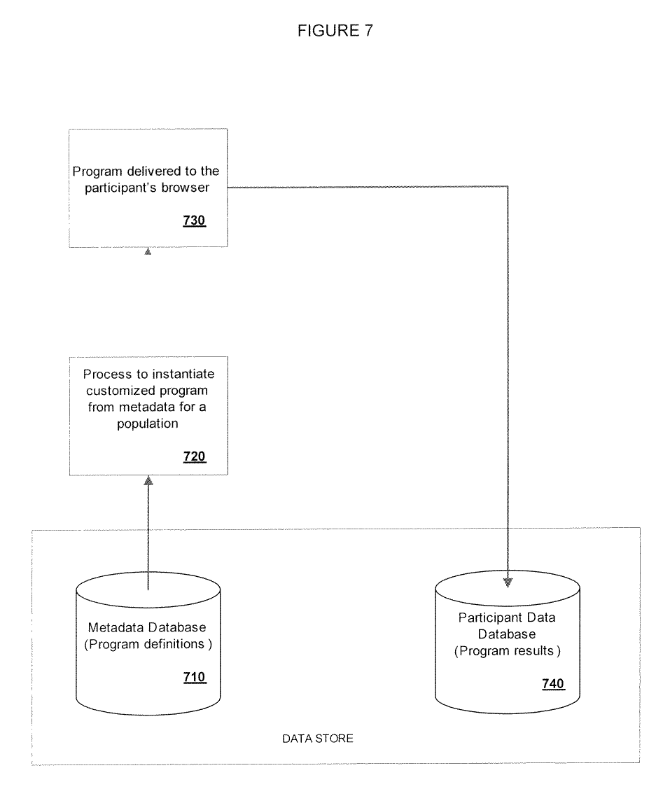

FIG. 7 is a diagram depicting the flow and storage of data involved in the implementation of a health improvement program, according to one embodiment. A metadata database 710 serves as a repository for all program information and program templates. The process to instantiate a personalized program 720 uses data from the metadata database 710 for each population to build a health improvement program application or user interface. A personalized health improvement program is delivered to the participant's system 730 in the form of a user interface. As participants work through their personalized programs, progress data and incentive points earned are stored in a participant data database 740.

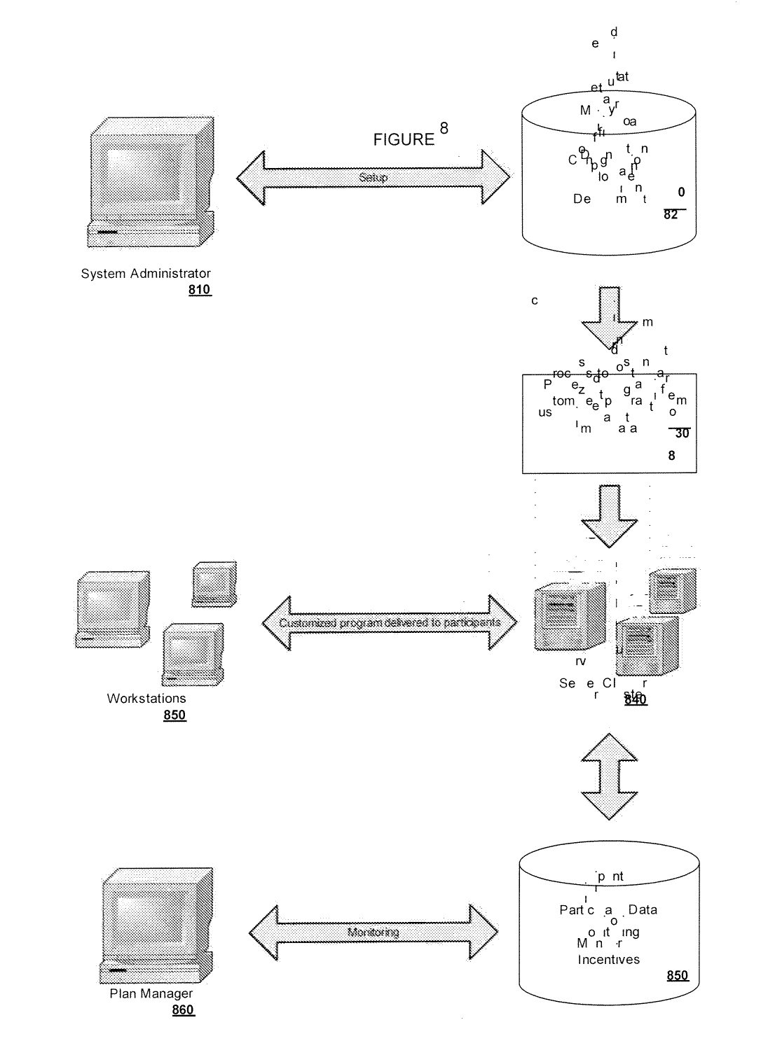

FIG. 8 is a block and flow diagram depicting the process of implementing a health improvement program, according to one embodiment. A system administrator 810 defines metadata elements 820 that represent components of a health improvement program and are stored in the program definition database 710. The system administrator 810 configures health improvement program templates for specific programs from these metadata definitions. The system administrator 810 customizes program templates for a specific population and adds population specific program dates, incentive values and budget limits. A customized run-time application or user interface is instantiated 830 based on the definitions provided by the system administrator in 810. The run-time application or user interface is loaded onto the server cluster 840 for delivery to program participants 730. Participants may access their personalized program user interface in real-time from any workstation running an Internet browser. Plan managers 860 within each population gain access to participant data 850 for the population to allow progress monitoring and incentive tracking.

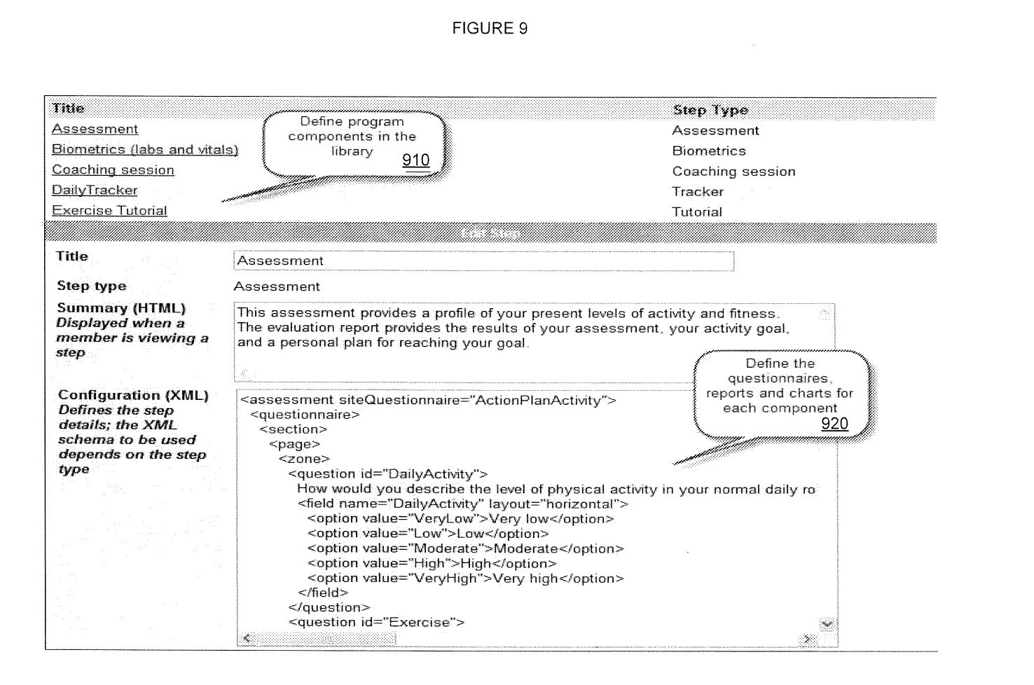

FIGS. 9 to 12 illustrate sample user interfaces that are representative of the preferred embodiment and are not intended to limit the scope of the invention.

FIG. 9 illustrates a user interface for defining program components, according to one embodiment. In the preferred embodiment, XML script is used to define the questions, responses, reports, and charts 920 that are used in the defined program components 910.

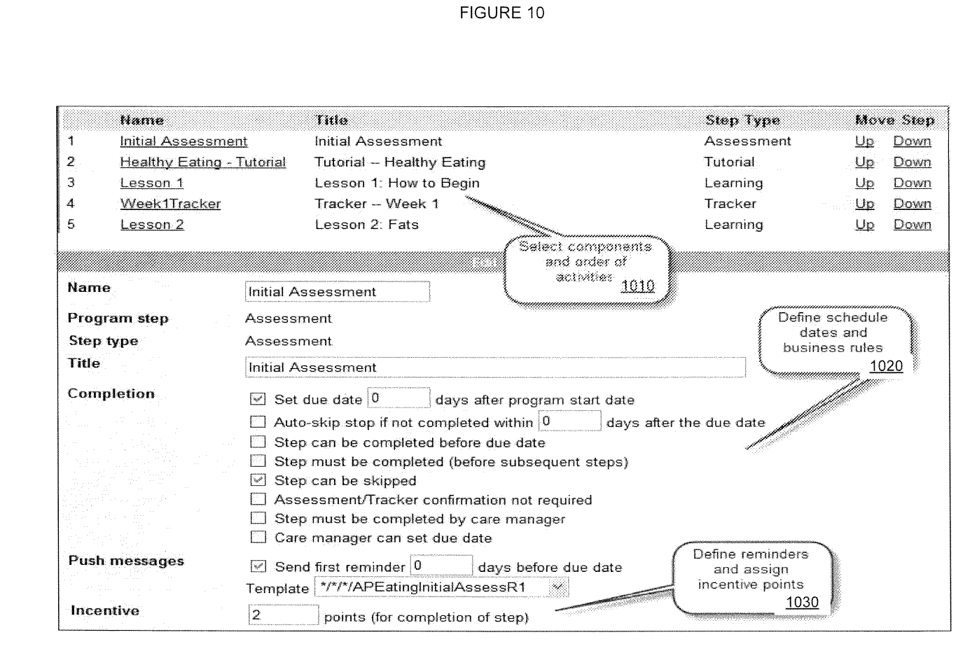

FIG. 10 illustrates a user interface for configuring program templates from program components, according to one embodiment. A user may select the program components and order of activities 1010, define the schedule dates and business rules for completion of each activity 1020, and define reminders and assign incentive points 1030.

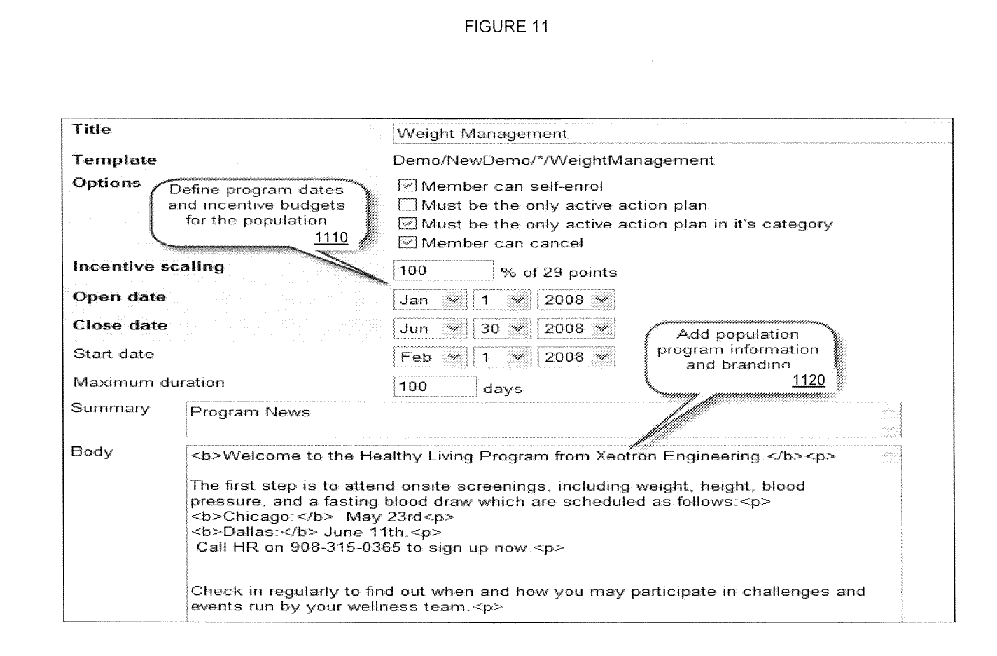

FIG. 11 illustrates a user interface for assigning program templates configured to specific populations and for customizing assigned templates to meet requirements of a given population, according to one embodiment. A user may define the dates on which a program is made available and the value of incentives offered 1110, as well as add population specific program information and branding 1120.

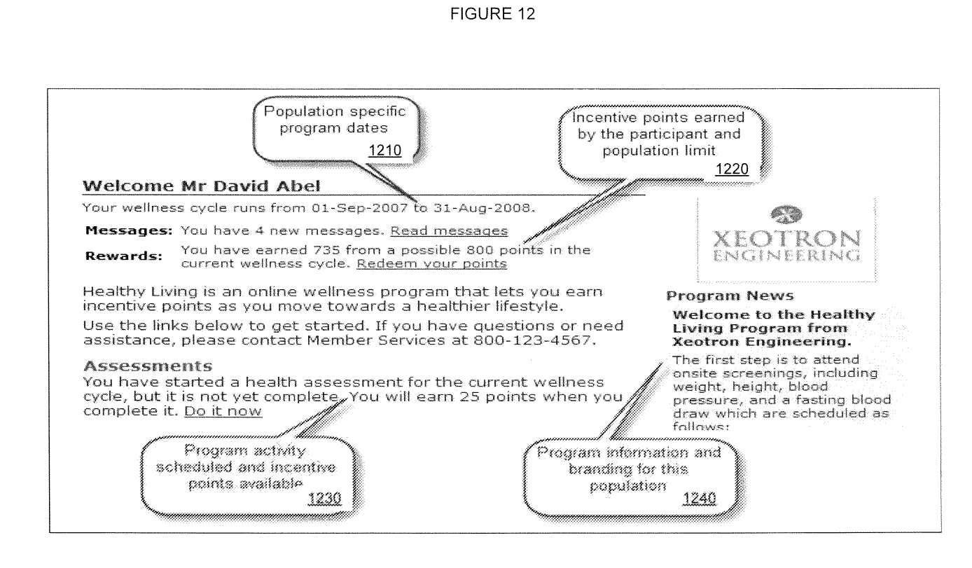

FIG. 12 illustrates a user interface for delivering customized programs to participants within a population, allowing a participant to complete activities, earn incentive points, and monitor his/her progress through the program, according to one embodiment. The delivered program user interface includes population specific program dates 1210, program activities scheduled and incentive points available 1220, and details of incentive points earned by a participant and the population budget limit 1230. The user interface also includes program information and branding for this population 1240.

All tasks described herein are part of the preferred embodiment and are not intended to limit the scope of the invention. All tasks performed by a system administrator or wellness provider or plan manager may, in another embodiment, be performed by a computer program or system. Likewise all tasks performed by a system or computer program may, in another embodiment, be performed by a system administrator, wellness provider, or plan manager.

A method and system for system for defining, configuring, deploying, delivering, and monitoring health improvement programs have been described. Although various embodiments have been described with respect to specific examples and subsystems, it will be apparent to those of ordinary skill in the art that the concepts disclosed herein are not limited to these specific examples or subsystems but extends to other embodiments as well. Included within the scope of these concepts are all of these other embodiments as specified in the claims that follow.

We claim:

1. A method, comprising:
defining health improvement program components;
assembling the health improvement program components into a plurality of configured health improvement program templates;
customizing one or more program templates of the plurality of configured health improvement program templates to meet the requirements of a given population;
deploying the one or more health improvement program templates to a plurality of program participants within the population;
delivering a personalized health improvement program for each participant of the plurality of program participants within the population; and
monitoring participant progress.

2. The method of claim 1, wherein health improvement program components comprise data collection items, question and corresponding response combinations, assessment algorithms, reminder messages, available reports and charts, lesson content, health improvement program templates, health improvement program dates, incentive values, and incentive budgets.

3. The method of claim 1, wherein assembling health improvement components into a configured health improvement program template comprises:
selecting defined health program components;
defining a schedule of health improvement program activities;
defining business rules for health improvement program assignment.

4. The method of claim 1, wherein deploying the configured health improvement program to a plurality of populations each comprising a plurality of program participants comprises:
selecting one or more health improvement plan templates;
defining health improvement program dates;
defining an incentive budget, and
adding population specific business rules and branding information.

5. The method of claim 1, wherein delivering a personalized health improvement program for a program participant comprises:
collecting information relating to the program participant's health history and lifestyle behaviors;
enrolling the program participant in one or more programs based upon the collected information;
the program participant earning incentives in accordance with defined business rules; and
reviewing program participant progress.

6. The method of claim 1, wherein monitoring participant progress comprises calculating incentives earned by a participant and reporting participant progress to community managers at a specified time interval.

7. A computer readable medium, whose contents cause a computing system to deliver a health improvement program, the contents cause the computing system to:
generate a customized health program for a program participant in a given population comprising a plurality of program participants, wherein generating the customized health program comprises:
receiving defined health program components;
receiving defined population program information;
receiving program participant information; and
generating a customized health program based upon the defined health program components, the defined population program information, and program participant information; and
render a customized user interface for presenting the customized health program to the program participant.

8. The computer readable medium of claim 7, wherein defined health program components comprise data collection items, question and corresponding response combinations, reminder messages, assessment algorithms, available reports and charts, lesson content, health improvement program templates, health improvement program dates, incentive values, incentive budgets.

9. The computer readable medium of claim 7, wherein program participant information comprises responses to assessment questionnaires, the assessment questionnaires generated using defined question and corresponding response combinations.

10. The program participant information of claim 9, further comprising collected information relating to a program participant's health history and lifestyle behaviors.

10. The computer readable medium of claim 7, wherein the customized user interface comprises population specific health program dates, health improvement program activities, incentive point information, population branding information.

11. A system for implementing a health improvement program, comprising:
a system administrator in communication with a database for storing health improvement program metadata;
a system that customizes a health improvement program in communication with the database for storing health improvement program metadata;
a server cluster that stores customized programs in communication with program participant workstations, and
a plan manager in communication with a participant data database.
